(19) United States
(12) Patent Application Publication
(10) Pub. No.: US 2012/0033347 A1
(43) Pub. Date: Feb. 9, 2012

(54) ELECTROCHEMICAL CAPACITORS

(75) Inventor: Thor E. Eilertsen, Oneonta, NY (US)

(73) Assignee: IOXUS, INC., Oneonta, NY (US)

(21) Appl. No.: 13/025,510

(22) Filed: Feb. 11, 2011

Related U.S. Application Data
(60) Provisional application No. 61/303,734, filed on Feb. 12, 2010.

(51) Int. Cl. H01G 9/155

(52) U.S. Cl. 361/502; 29/25.03

(57) ABSTRACT

A method of manufacturing an electrode includes printing an electrode ink on a portion of a substrate using a rotary lithographic printer. The electrode ink is allowed to dry on the substrate. A separator material is printed on the portion of the substrate using the rotary lithographic printer. A sealant wall is printed around the portion of the substrate using the rotary lithographic printer. The substrates are then “stacked” and “folded” in appropriate configurations to obtain a desired capacitance and voltage standoff.

### CROSS-REFERENCE TO RELATED APPLICATION

This application claims priority to U.S. Provisional Patent Application No. 61/303,734, filed Feb. 12, 2010, and entitled FOLDING STACKING MACHINE, the contents of which are incorporated by reference in their entirety.

### BACKGROUND

The present invention relates to high voltage electrochemical double layer capacitors (EDLCs) and, more particularly, to manufacturing methods and equipment to create electrodes for a high voltage device (HVD), while maintaining high capacitance and low resistance thereof.

An electrochemical double layer capacitor (EDLC) is an energy storage device consisting of two electrodes arranged in such a manner that one acts as the cathode and the other the anode, creating a structure that can be modeled as two capacitors in series. The device is characterized by a high power density whose value can be dictated by the effective series resistance (ESR) of the device (i.e., the lower the ESR, the higher the power density). The capacitance of EDLCs can be large due to the effective surface of activated carbon used to fabricate an EDLC and the spacing between the electrode and the molecules of the electrolyte that form the double layers. The capacitance of an EDLC can be calculated using the formula C=kA/d, where k is a constant of proportionality, A is the effective surface area of the activated carbon, and d is the spacing between the electrode and the electrolyte molecules.

EDLC devices can be manufactured by encasing electrodes and separator material in a package which is wetted with electrolyte and sealed. The resulting device is a single cell EDLC device. These devices can be used in a wide variety of applications including but not limited to industrial power supplies, UPS (uninterrupted power supplies), electric vehicles, cell phones, and electronic appliances.

Known EDLCs operate with a nominal voltage rating of approximately 2.7 volts, a limitation imposed by virtue of the electrolyte. In some applications, more than a single EDLC cell is required to meet the needs of a particular application. For example, one or more EDLC devices can be coupled in series to provide a composite device that operates at a higher voltage. However, if the cells are not balanced as the number of cells in series increases premature failure of the composite device can occur. Additionally, the increase of the ESR of the cells in series can result in a decrease in power density.

### SUMMARY

A method of manufacturing an electrode includes printing an electrode ink on a portion of a substrate using a rotary lithographic printer. The electrode ink is allowed to dry on the substrate. A separator material is printed on the portion of the substrate using the rotary lithographic printer. A sealant wall is printed around the portion of the substrate using the rotary lithographic printer. The substrates are then “stacked” and “folded” in appropriate configurations to obtain a desired capacitance and voltage standoff.

### BRIEF DESCRIPTION OF THE DRAWINGS

FIG. 1 illustrates the folding organization patterns used to complete each cell sequentially, according to an embodiment.

FIG. 1A is a schematic illustration of a rotary lithographic printer, according to an embodiment.

FIGS. 1B-1D are schematic illustrations of various electrode arrays printed using the rotary lithographic printer of FIG. 1A.

FIG. 1E is a flow chart illustrating a method of printing an electrode, according to an embodiment.

FIG. 2 shows a component selection and specific placement thereof, according to an embodiment.

FIG. 3 illustrates the folding organization patterns used to complete each cell sequentially, according to an embodiment.

FIG. 3A is a schematic illustration of three stacks of electrodes connected in parallel, according to an embodiment.

FIGS. 4A-4R are schematic illustrations of a machine performing a sequence of folding stacking steps, according to an embodiment.

FIGS. 5A-5C are schematic illustrations of a folding stacking machine, according to an embodiment.

FIGS. 5D and 5E are photographs of a folding stacking machine, according to an embodiment.

### DETAILED DESCRIPTION

The development of a HVD requires that multiple single cell EDLCs be configured in series parallel configurations to produce a single monolithic device with a higher voltage rating than can be currently obtained using single cell construction. Embodiments of electrode materials and structures for EDLCs are generally described in pending U.S. patent application Ser. No. 12/151,811, filed May 8, 2008, entitled “Electrode Structure for the Manufactures of an Electric Double Layer Capacitor,” which is incorporated herein by reference in its entirety. The electrode material for production of HVDs is produced using a proprietary printing process that employs specialized materials that include the electrode materials, sealing surfaces to enclose individual single cells, and separator material. Embodiments of such printed electrodes are generally described in International Patent Application No. PCT/US09/55299, filed Aug. 28, 2009, entitled “High Voltage EDLC Cell and Method for the Manufacture thereof,” which is incorporated herein by reference in its entirety.

In some embodiments, a method of manufacturing an electrode includes printing an electrode ink on a portion of a substrate using a rotary lithographic printer. The electrode ink is allowed to dry on the substrate. A separator material is printed on the portion of the substrate using the rotary lithographic printer. A sealant wall is printed around the portion of the substrate using the rotary lithographic printer. The substrates are then “stacked” and “folded” in appropriate configurations to obtain a desired capacitance and voltage standoff.

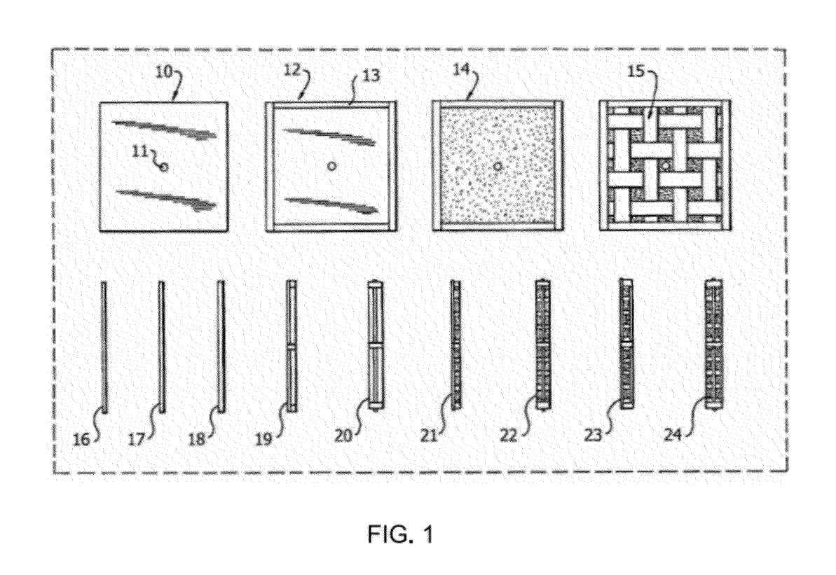

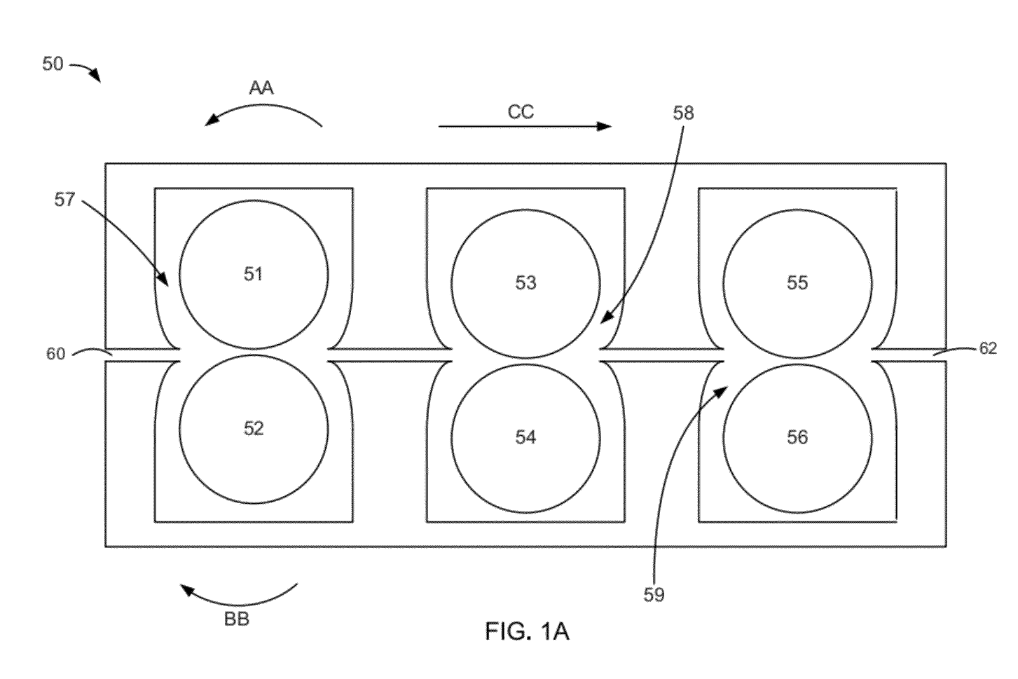

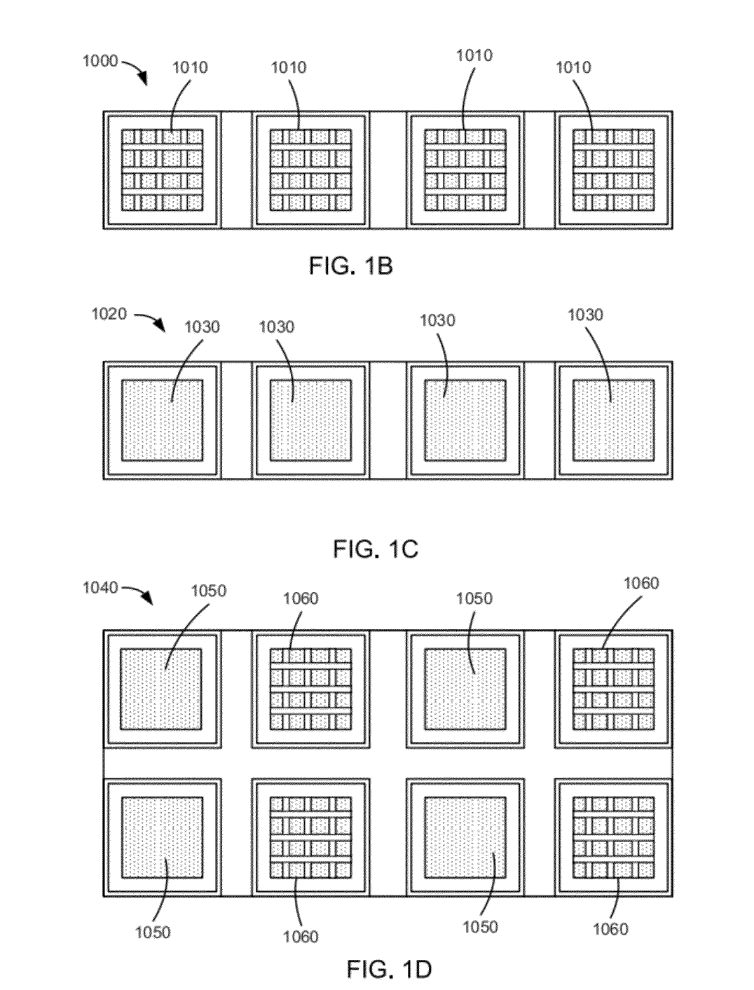

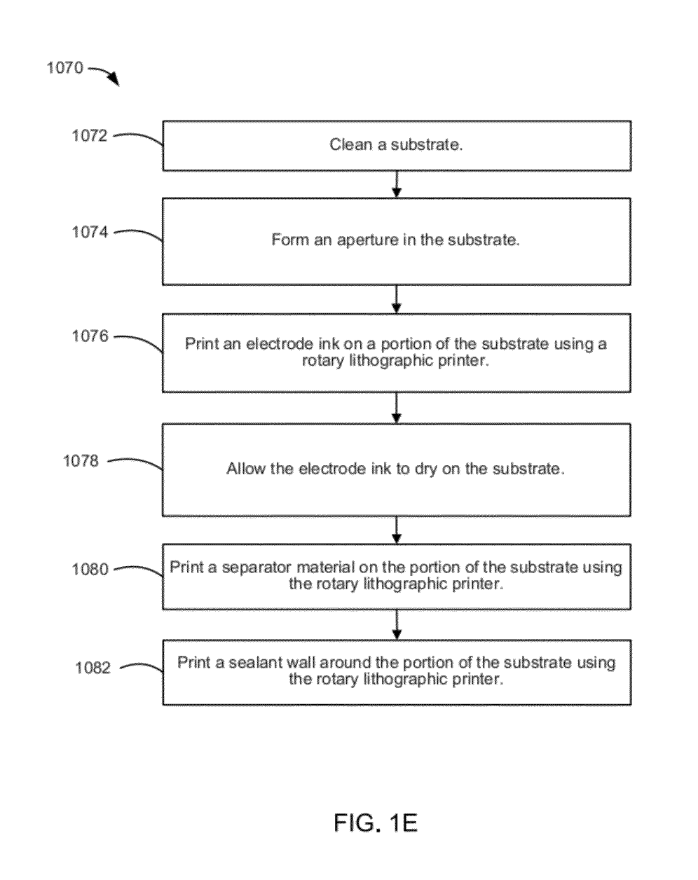

FIG. 1 illustrates an electrode (e.g., a half-cell) throughout various stages of the manufacturing process. Plan views of the manufacturing stages of the electrode are identified by reference numerals 10, 11, 12, 13, 14 and 15, shown on the upper portion of FIG. 1, while the respective cross-sectional thickness of single and double layer electrodes are identified by reference numerals 16, 17, 18, 19, 20, 21, 22, 23 and 24, shown on the lower portion of FIG. 1.

A current collector (e.g., a substrate) 10, 16 can be constructed of any suitable material. For example, in some embodiments, the current collector 10, 16 is constructed of capacitor grade aluminum (e.g., 99.99% pure aluminum). In other embodiments, the current collector can be constructed of tantalum and/or the like. The current collectors 10, 16 can be available in sheets. In some embodiments, for example, a sheet can have a thickness of 30 μm, a width of 50 mm and a length of 50 mm. In other embodiments, the sheets can be any suitable size. For example, in other embodiments the sheet can have a thickness of 40 p.m. The substrate material can be obtained in large rolls and can be slit to appropriate dimensions for the fabrication of a particular device. In some embodiments, stationary knives are used to slit the substrate material to the appropriate dimensions. Such stationary knives can be used to make a clean accurate cut that does not cause rolled edges on the substrate. The process, as mentioned above, can be used for virtually any size capacitor and the device capacitance is dependent upon the size of the half-cell structures, described in further detail herein.

In some embodiments, the current collector 10, 16 can be cleaned. Such cleaning can help prevent the current collector from forming contaminates that can reduce the strength of the bond between the electrode material and the current collector 10, 16 when the electrode material is formed on the current collector 10, 16, as further described in detail herein. For example, aluminum, when exposed to an oxygen atmosphere, can quickly form contaminates (e.g., aluminum oxide) that can impede the electrode material from bonding with an aluminum current collector. In some embodiments, plasma etching can be used to clean the current collector 10, 16. In such embodiments, plasma etching can be used as part of a printing process, as described in further detail herein. As such, an apparatus (such as apparatus 50 shown in FIG. 1A) can plasma etch the current collector 10, 16 prior to printing the electrode ink on the current collector 10, 16. In other embodiments, high voltage corona discharge can be used to clean the current collector 10, 16. In still other embodiments, chemical etchant baths can be used to remove such contaminates. In such embodiments, the electrode material can be printed on the current collector soon after the current collector is removed from the bath since an oxide layer can reform on an aluminum current collector in a matter of minutes.

A hole 11 is formed in the current collector 10, 16. The hole 11 can be formed using any suitable technique. In some embodiments, for example, the hole 11 can be drilled, cut, and/or the like. The hole 11 can be aligned with the holes formed in other current collectors. An electrolyte can be inserted into a stack of cells via the holes, as described in further detail herein.

A sealant material 12 is formed around the perimeter of the current collector 13. The sealant material 12 creates a sealant wall that will surround the carbonized material, as described in further detail herein. The sealant material 12 can be a polymer configured to adhere to the sealant material on another current collector 13 to form a hermetically sealed barrier between the cell and the external atmosphere. In such a manner, two half-cells are combined to make a full cell. In some embodiments, a polyvinylidene fluoride (PVDF) material, such as, for example, Solef 1008 manufactured by Solvay-Solexis, can be used. Such a material can include desired properties such as operating temperature, surface adhesion, flexibility, and chemical solubility. In other embodiments, a CL-5-1 sealant material can be used. In some embodiments, the sealant material 12 can have a thickness of less than 100 μm for a single side 19 and less than 170 μm for a double sided component 20 (e.g., when the sealant material 12 is printed on both sides of the current collector 13). The application of the sealant material can be through a lamination process, screen printing and/or lithographic printing, as further described herein. The sealant material 12 forms a wall around the perimeter of the current collector 13 that is immune to decay from electrolyte exposure and prevents leakage of electrolyte from the cell.

In some embodiments, the portion of the current collector on which the sealant material is formed can be perforated with micro holes such that the sealant material formed on a first surface of the current collector can be coupled with the sealant material formed on a second surface of the current collector. In such embodiments, for example, the sealant material on the first surface of the current collector can be monolithically formed and/or fused with the sealant material on the second surface of the current collector. This can help stabilize the wall created by the sealant material on both surfaces of the current collector.

An electrode ink is applied to the current collector 14. A side view 21 of the current collector 14 having electrode ink applied on a single side of the current collector 14 and a side view 22 of the current collector 14 having electrode ink applied to both sides of the current collector 14 are shown in FIG. 1. The electrode ink can be any suitable electrode ink. In some embodiments, for example, the electrode ink can be a carbon slurry similar to that described in U.S. patent application Ser. No. 12/151,811, filed May 8, 2008, entitled “Electrode Structure for the Manufacture of an Electric Double Layer Capacitor,” which is incorporated herein by reference in its entirety. The electrode ink can be composed primarily of activated carbon (e.g., MSP-20), smaller quantities of conductive carbon (e.g., Super P), rubberizers (e.g., BM-400-B), binders (e.g., polytetrafluoroethylene (PTFE), polyvinylpyrrolidone (PVP)), fillers (e.g., Cab-o-sil), distilled water and/or other additives (e.g., carboxymethyl cellulose (CMC)). In some embodiments the electrode ink can be formed by mixing proper proportions of the ingredients in a specific order, half mixing with itself and with a solvent. Once mixed, the electrode ink can be applied to the current collector (e.g., substrate). The electrode ink mixture has enhanced electrical properties that reduce the bonding resistance and increase the capacitance of the electrode ink promoting a unique cast component solution. In other embodiments, the electrode ink can include ceramics and/or the like.

Activated carbon, the predominant ingredient in an EDLC carbon electrode, provides massive exposed surface areas used to create the capacitive storage in high voltage EDLC applications. The capacitance of a cell is proportional to the volume of the activated carbon within the cell. In some embodiments, a specific value can be obtained by taking the product of the cell volume times the specific capacitance per unit volume with the latter being relatively constant up to a moderate thickness. In other embodiments, the capacitance can be obtained using the specific capacitance per unit area times the area of a cell. As discussed in further detail herein, arranging multiple cells in series and parallel can reduce the ESR of the electrode and thus increase the power density of the electrode. Such an arrangement can also increase the current carrying capability of the device.

Differing applications dictate the relative importance of power vs. energy density. The manufacturing process may be adjusted to prioritize either. In some embodiments, for example, the thickness of the electrode ink on the current collector and the adhesive thickness of the sealant material on the current collector can be increased to increase the energy provided by the cell. As further described in detail herein, the thickness of the electrode ink on the current collector can be varied by a thickness of a screen (e.g., a mesh) used in a lithographic printing process. As mentioned above controlling the thickness in turn changes the energy density of the individual half-cells.

In order to maximize the working voltage of the EDLC device, a proton conductor or separator 15 can be disposed between individual polarized half-cells in order to electrically isolate but not chemically separate the half-cells. The separator 15 can also be configured such that only specific charged ions can pass through the separator 15. The separator 15 can also store a limited amount of free electrolyte not absorbed into the activated carbon. The separator 15 can be inserted or printed on one of the half-cell strips using lithographic techniques, described in further detail herein.

The separator 15 undergoes high mechanical stress, both in vertical and horizontal directions, as the EDLC is charged and discharged in operation. The separator 15 adds its own resistive quantities measured as a constant in one direction or the opposite direction, and as some reactive component as a frequency dependent quantity. In some embodiments, a lithographic printing process can be used to print the separator material onto the electrode ink, since precession location, material concentration, spacing, sizing and adaptability are important parameters and may be more easily attained using a lithographic printing process.

In some embodiments, the separator 15 can be constructed of a polyvinylidene fluoride (PVDF), such as, for example, Solef 6020 manufactured by Solvay-Solexis. In other embodiments, the separator can be constructed of rubberizers (e.g., BM-440-B), binders (e.g., polytetrafluoroethylene (PTFE), polyvinylpyrrolidone (PVP)), fillers (e.g., cab-o-sil), distilled water and/or other additives. In such embodiments, the cab-o-sil forms a permeable membrane configured to allow electrolyte ions to pass through the separator material.

The separator 15 can be screen and/or lithographically printed onto the prepared, dried electrode ink, as described in further detail herein. In some embodiments, for example, the separator 15 can have a maximum applied thickness of 25 μm, a pore size of 25 to 50 μm with an evenly distributed pore size distribution (PSD) and a homogenous separator matrix composition. The pore size can dictate the rate of electrolyte migration in the cells. A small pour size, for example, can reduce the rate of electrolyte migration in the cells which can slow the response of the capacitor. Depending on the power or energy requirements of the final high voltage EDLC, the screening application process can compensate for other material or manufactured defects. A single sided electrode 23 with a screened separator and a double-sided electrode 24 (e.g., a half-cell printed on both surfaces of a current collector) with screened separator are shown in FIG. 1. In some embodiments, the separator can be as thin as possible to provide sufficient isolation to prevent the two half-cells from shorting together. In some embodiments, only one separator 15 is required between each half-cell assembly, so alternate placement from the screening applicator may be possible. Accordingly, as described in further detail herein, a separator 15 is not printed on every current collector. After a completed half-cell is printed on a first surface of the current collector, a half-cell can be printed on a second surface of the current collector using a similar process.

In other embodiments, the separator can be placed onto the prepared, dried electrode ink using methods other than printing. For example, a premade separator sheet can be placed and/or laminated onto the dried electrode ink. Some separator materials used in such embodiments operate best when formed prior to being placed onto the dry electrode ink. Such materials are available from manufactures such as Celgard and NKK. The operation parameters of such separator materials can be predefined and tested by the manufacturer and, as such, the materials can operate as tested under various conditions. Such separators can be physically applied to the current collector over the electrode ink as the electrodes are manufactured or such separators can be laminated prior to assembly of the electrode.

FIG. 1A is a schematic illustration of a rotary lithographic printer 50 used to manufacture an electrode, such as the half-cells shown and described in FIGS. 1B-1D, according to an embodiment. The rotary lithographic printer 50 includes a first pair of rotating drums 57, a second pair of rotating drums 58 and a third pair of rotating drums 59. The first pair of rotating drums 57 includes a top drum 51 and a bottom drum 52. The top drum 51 is a print head containing electrode ink. In some embodiments, an outer mesh layer (not shown in FIG. 1A) is coupled to the top drum 51. The top drum is configured to press the electrode ink through the outer mesh layer and onto a current collector (e.g., a substrate) when the current collector is passed between the top drum 51 and the bottom drum 52.

The top drum 51 is configured to rotate about a center axis in the direction shown by the arrow AA in FIG. 1A. Similarly, the bottom drum 52 is configured to rotate about a center axis in the direction shown by the arrow BB in FIG. 1A. Accordingly, when a substrate is passed between the top drum 51 and the bottom drum 52, the substrate is moved in a direction shown by the arrow CC in FIG. 1A. This allows the top drum 51 to print the electrode ink onto the substrate as the substrate is moved in the direction shown by the arrow CC.

In some embodiments, the top drum 51 prints the electrode ink in a pattern across the substrate. In such embodiments, for example, the top drum 51 can print an array of rectangles across a long strip of substrate. Such an array of rectangles can be similar to those shown in FIGS. 1B-1D. In other embodiments, any other pattern can be printed, such as, for example, a pattern of triangles, circles, ovals and/or the like.

The thickness of the electrode ink printed onto the substrate can be varied by varying the outer mesh layer coupled to the top drum 51. For example, if a thicker layer of electrode ink is desired, the thickness of the outer mesh layer can be increased. Further, if a thinner layer of electrode ink is desired, the thickness of the outer mesh layer can be decreased. Varying the thickness of the electrode ink varies the capacitance of the device. An optimal thickness of the electrode ink can be determined by printing samples and measuring the capacitance per unit volume of the samples. If the electrode ink is too thick, the electrode ink spaced far from the current collector does not function as intended and can reduce the migration of electrolyte ions and thus the conduction rate across the separator layer. If the electrode ink is too thin, the capacitance of the device can be less than the capacitance of an electrode having electrode ink layer with optimal thickness.

Similar to the first pair of rotating drums 57, the second pair of rotating drums 58 includes a top drum 53 and a bottom drum 54. The top drum 53 is configured to rotate about a center axis in the direction shown by the arrow AA in FIG. 1A. Similarly, the bottom drum 54 is configured to rotate about a center axis in the direction shown by the arrow BB in FIG. 1A. Accordingly, when a substrate is passed between the top drum 53 and the bottom drum 54, the substrate is moved in a direction shown by the arrow CC in FIG. 1A.

The top drum 53 is a print head containing separator material. In some embodiments, an outer mesh layer (not shown in FIG. 1A) is coupled to the top drum 53. The top drum 53 is configured to press the separator material through the outer mesh layer and onto a substrate on which electrode ink has been printed when the substrate is passed between the top drum 53 and the bottom drum 54.

In some embodiments, the top drum 53 prints the separator material onto the substrate in a pattern across the electrode ink. In such embodiments, for example, the top drum 51 can print an array of rectangular strips across a portion of a substrate on which electrode ink has been printed. Such an array of rectangular strips can be similar to those shown in FIGS. 1B and 1D. In other embodiments, any other pattern can be printed.

As discussed above, in some embodiments, the separator material is not printed on every current collector. For example, FIG. 1C shows a strip of substrate 1020 with half-cells 1030 on which separator material is not printed. To achieve such a result, the top drum 53 can be configured to print the separator material on some current collectors and not others.

Similar to the first pair of rotating drums 57 and the second pair of rotating drums 59, the third pair of rotating drums 59 includes a top drum 55 and a bottom drum 56. The top drum 55 and the bottom drum 56 are configured to rotate similar to the top drum 51 and the bottom drum 52, described above. The top drum 55 is a print head containing sealant material. In some embodiments, an outer mesh layer (not shown in FIG. 1A) is coupled to the top drum 55. The top drum 55 is configured to press the sealant material through the outer mesh layer and onto a substrate when the substrate is passed between the top drum 53 and the bottom drum 54. The sealant material can be printed such that sealant material surrounds the portion of the substrate on which the electrode ink is printed.

In use, a piece of substrate material (e.g., aluminum) is inserted into the apparatus 50 at point 60. Because of the rotational motion of the rotating drum pairs 57, 58, 59, the substrate material is moved in the direction shown by the arrow CC. As the substrate material passes through the first pair of rotating drums 57, the top rotating drum 51 prints electrode ink on the substrate. As discussed above, in some embodiments, the top rotating drum 51 can print a pattern of electrode ink on the substrate, such as, for example, an array of rectangles.

The piece of substrate material then passes from the first pair of rotating drums 57 to the second pair of rotating drums 58. The distance between the first pair of rotating drums 57 and the second pair of rotating drums 58 can be large enough to allow the electrode ink printed on the substrate by the first pair of rotating drums 57 to dry on the substrate before the substrate reaches the second pair of rotating drums 58. In other embodiments, the electrode ink need not be dried prior to printing the separator material on the substrate. After the substrate contacts the second pair of rotating drums 58, the top rotating drum 53 prints the separator material on the substrate in the desired pattern and location. In some embodiments, for example, the separator material is printed on only some of the half-cells. The piece of substrate material then passes from the second pair of rotating drums 58 to the third pair of rotating drums 59. The top rotating drum 55 prints the sealant material around the perimeters of the portions of the substrate on which the electrode ink was printed.

The printed substrate (e.g., completed half-cell strip) can then exit the apparatus at point 62. The piece of substrate material can then be turned over and inserted through the apparatus 50 such that the electrode ink, the sealant material and optionally, the separator material is printed on a second surface of the substrate. The positioning of the components already printed on the first surface of the substrate (e.g., the electrode ink, the separator material and the sealant material) as the components are printed onto the second surface of the substrate can be monitored using optical sensors (not shown) positioned on the apparatus 50. Such optical sensors can help ensure that the half-cells printed on the second surface of the substrate are aligned with the half-cells printed on the first surface of the substrate. In other embodiments, any other suitable method and/or device is used to monitor the positioning of the components already printed on the first surface of the substrate as the components are printed onto the second surface of the substrate. In still other embodiments, half-cells are printed on the second surface of the substrate by the bottom rotating drums as the top rotating drums print the half-cells on the first surface of the substrate. In such embodiments, only a single pass through the apparatus 50 is necessary to print half-cells on both sides of the substrate.

In some embodiments, as each component (e.g., the electrode ink, the separator material and the sealant material) is applied, drying time can be modified (e.g., longer or shorter), as the substrate is wound onto a large round drum that may be oil heated to maintain a satisfactory drying temperature. The large drum may also be considered a storage vehicle to allow more substrate material in a smaller length of area and not condensing it into a compact reel thus possibly damaging the integrity of the sealant material and electrode ink.

While shown in FIG. 1A as printing the sealant material onto the substrate after printing the electrode ink and the separator onto the substrate, the sealant material can be printed onto the substrate at any point in the printing process. In some embodiments, for example, the sealant material is printed onto the substrate prior to printing the electrode ink and the separator material onto the substrate. In other embodiments, the sealant material is printed onto the substrate after printing the electrode ink onto the substrate but prior to printing the separator material onto the substrate.

While shown in FIG. 1A as having three rotating drum pairs 57, 58, 59, in other embodiments the apparatus can include a single rotating drum pair. In such embodiments, the top rotating drum can be reconfigured at each stage of the printing process. For example, the top rotating drum can first be configured to print the electrode ink on the substrate. The substrate can then be passed between the rotating drum pair and the electrode ink can be printed on the substrate. The top rotating drum can then be reconfigured to print the separator material on the substrate and the substrate can be passed between the rotating drum pair a second time such that the separator material is printed on the substrate. The top rotating drum can then be reconfigured to print the sealant material on the substrate and the substrate can be passed between the rotating drum pair a third time such that the sealant material is printed on the substrate.

FIGS. 1B-1D show examples of half-cell strips printed using the apparatus 50 of FIG. 1A. FIG. 1B, for example, shows a substrate 1000 with four half-cells 1010 printed thereon. The electrode ink, the separator material and the sealant material is printed on each of the four half-cells 1010. FIG. 1C shows a substrate 1020 with four half-cells 1030 printed thereon. The separator material is not printed on the four half-cells 1030 of substrate 1020. As described in further detail herein, the substrate 1000 can be coupled with the substrate 1020 to form multiple electrode cells connected in series.

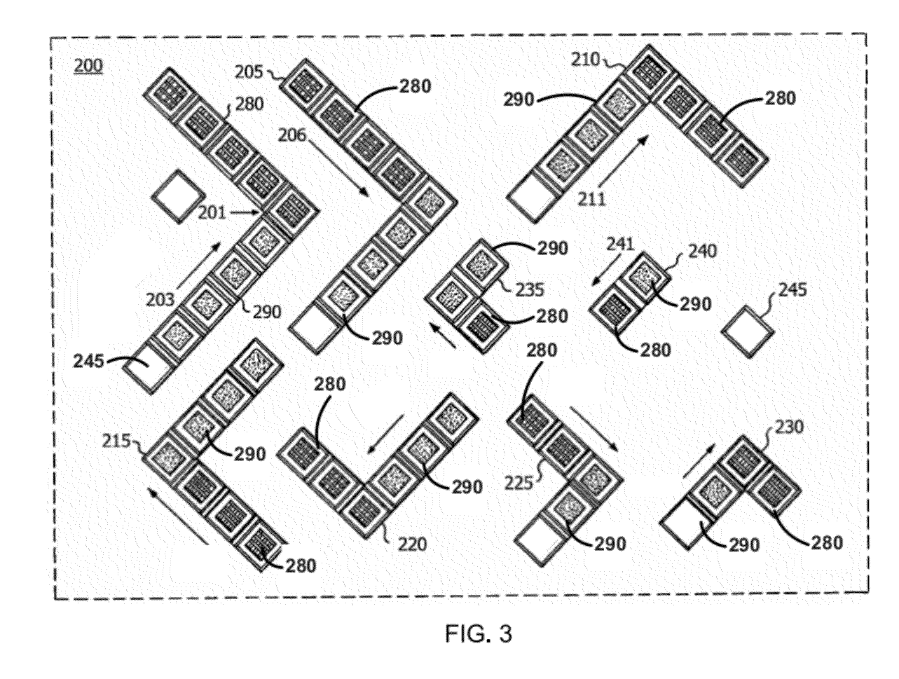

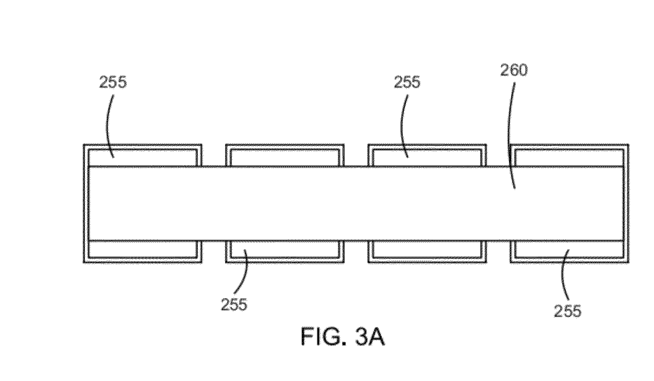

While FIGS. 1B and 1C show a single row of half-cells printed on a substrate, FIG. 1D shows a substrate 1040 having two rows of half-cells 1050, 1060 printed thereon. The separator material is printed on some half-cells 1060 while not printed on other half-cells 1050. In some embodiments, the substrate 1040 can be folded to provide a series connection between the electrodes in each row and a parallel connection between the electrodes in the two rows. In other embodiments, any number of rows and columns of any number of half-cells can be printed on the substrate. For example, FIG. 3 shows two substrates having five half-cells each.

FIG. 1E is a flow chart illustrating a method 1070 of printing half-cells of an electrode on a substrate. The method includes cleaning the substrate, at 1072. The substrate can be cleaned by, for example, plasma etching. Such cleaning can help prevent the current collector from forming contaminates that can reduce the strength of the bond between the electrode material and the current collector when the electrode material is printed on the current collector.

An aperture is formed in the substrate, at 1074. As discussed above, the aperture can be formed by any suitable method and electrolyte can be inserted into the aperture when the device is completed, as described in further detail below. An electrode ink is printed onto a portion of the substrate using a rotary lithographic printer, at 1076. The electrode ink can include activated carbon and can be similar to the electrode ink shown and described above. Further, the rotary lithographic printer can be similar to the apparatus 50 shown and described with relation to FIG. 1A.

The electrode ink is allowed to dry on the substrate, at 1078. A separator material is printed onto the portion of the substrate using the rotary lithographic printer, at 1080. The separator material can be similar to the separator material shown and described above. Moreover, the separator material can be printed onto the portion of the substrate in a specific pattern, such as, for example, the checkered pattern shown on the half-cells 1010 of substrate 1000 in FIG. 1B. A sealant wall is printed around the portion of the substrate using the rotary lithographic printer, at 1082. The sealant wall can be used to hermetically seal the half-cell with another half-cell to create a completed full cell.

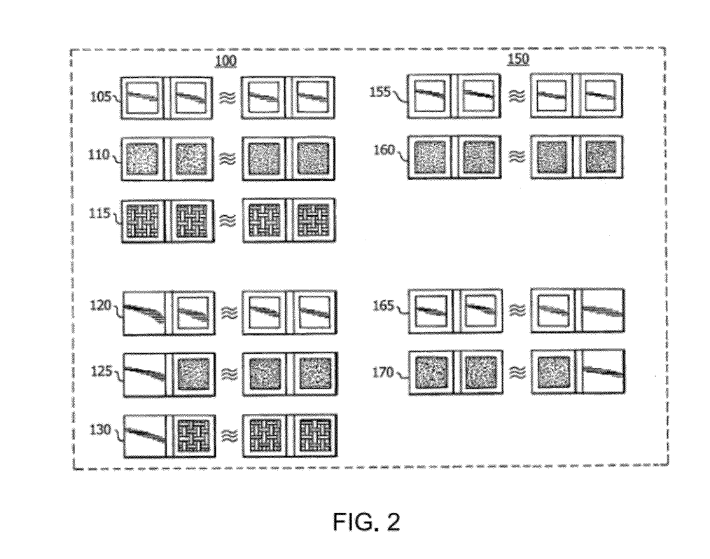

FIG. 2 details lithographic component plates, showing front 105, 110, 115 and back 120, 125, 130 sides of a first substrate 100 and front 155, 160 and back 165, 170 sides of a second substrate 150 at different stages within the printing process. Each component of the printing process (e.g., the electrode ink, the separator material and the sealant material) is sequentially applied onto the substrates 100, 150 until the components are completed. The components can be applied to each side of the substrates 100, 150 as described above. As shown in FIG. 2, the separator material is not applied to the second substrate 150.

Detailed information as to how the electrode components are assembled into the high voltage EDLC are referenced initially by the sample 90 degree lithographic component folding scheme shown in FIG. 3. A first half-cell strip 280 comprises elements 115 and 130 (FIG. 2) and a second half-cell strip 290 comprises elements 160 and 170 (FIG. 2) arranged 90 degrees offset from each other 200, both half-cell strips 280, 290 having the respective front sides facing up. A separator material is printed on the half-cells of the first half-cell strip 280 while a separator material is not printed on the half-cells of the second half-cell strip 290. As the half-cells of the first half-cell strip 280 are coupled to the half-cells of the second half-cell strip 290, each full cell will have a separator material between the electrode ink.

The folding pattern demonstrates how individual components are aligned. Beginning with folding pattern 200 of half-cell strip 280, the first bottom component 201 has bare aluminum ready for block assembly, described in further detail herein. Initially half-cell strip 290 slides down on top of half-cell strip 280 forming the first full cell component. The half-cell strip 290 is then folded over the half-cell strip 280 in the direction shown by the arrow 206, at 205. This fold forms a second full cell component. The half-cell strip 290 is then folded over the half-cell strip 280 in the direction shown by the arrow 211, at 210. This fold forms a third full cell component. This folding process is repeated at steps 215, 220, 225, 230 and 235 until the last folding pattern 240, folds the half-cell strip 290 over the half-cell strip 280 in the direction shown by the arrow 241 and the operation is complete with the top end component 245 of half-cell strip 290 on top of the additive capacitive block. Such a folding process produces a stack of multiple full cells connected to each other in series. For example, in FIG. 3, the folding process results in a stack of nine full cells connected in series.

As each of these electrode assemblies is built, it is targeted for specific sections, being defined as block and block interface coupling areas. The most straightforward is the block area. In this area, the two electrodes are intertwined, coupling the carbon-to-carbon interface together with only one thin separator sandwiched between them. As each electrode is advanced, it is folded 90 degrees to the second electrode with each electrode being placed down in series to the other. Every second time an electrode is placed down, an additive capacitive component is created. As long as each electrode is interfacing in this series fashion with continuous lengths of current collector matching, the capacitance is additive.

At the beginning of the electrode, a carbon mass-free aluminum current collector component is provided (e.g., bottom component 201 in FIG. 3). This also occurs at the very end of the completed EDLC block (e.g., component 245 in FIG. 3). These bare aluminum segments, at least on one side, when the EDLC is first connected to a positive and negative power source, act as the terminal interface.

A stack produced by the folding process 200 of FIG. 3 can be coupled to other similar stacks in parallel. For example, FIG. 3A shows four stacks 255 coupled to each other in parallel by a conductor 260 (e.g., a piece of aluminum). Specifically, the conductor 260 is coupled to the top bare component (e.g., component 245 in FIG. 3) of each of the stacks 255. Similarly, the bottom bare component (e.g., component 201) of each of the four stacks 255 is coupled to the bottom bare component of the other stacks by a conductor (not shown in FIG. 3A). Such a series/parallel configuration (e.g., cells coupled in series within each stack and cells coupled in parallel between each stack) can increase the power density of the device. Such configurations reduce the ESR and thus increase the power density and provide a device having a more robust current carrying capability than a single stack of cells.

Depending on the structural size and organization of these component areas, orienting length, width and thickness in parallel and/or series compartments provides greater capacitance and/or voltage standoff capability, respectively. To illustrate suppose multiple half-cell strips have been joined forming an EDLC device with n individual cells in series (e.g., the number of cells in each stack 255) and m in stacks in parallel (e.g., the number of stacks 255). The capacitance of each stack can be equal to the capacitance of each cell divided by the number of cells in each stack (C_{stack}=C_{cell}/n). The voltage standoff of each stack can be equal to 2.5 times the number of cells in each stack (V_{standoff}=2.5×n). The capacitance of the device can be equal to the number of stacks times the capacitance of each cell divided by the number of cells in each stack (Cₜₒₜₐₗ=(m×C_{cell})/n). The ESR of such a device can be the ESR of each stack divided by the number of stacks (ESRₜₒₜₐₗ=ESRₛₜᵣᵢₚ/m).

Printing the electrode strips provides dimensional precision for long strips of electrode material that can then be folded and stacked to yield series connected strings. The series connection is required to obtain the voltage standoff, which may be determined by multiplying the number cells in series time the unit cell voltage, for example, 2.5 volts; thus a series string of six cells would have a voltage rating of 15 Volts. Once the strips have been printed in strips they must be folded and stacked to form the high voltage cell, and this is accomplished using the folding stacking machine that is described below.

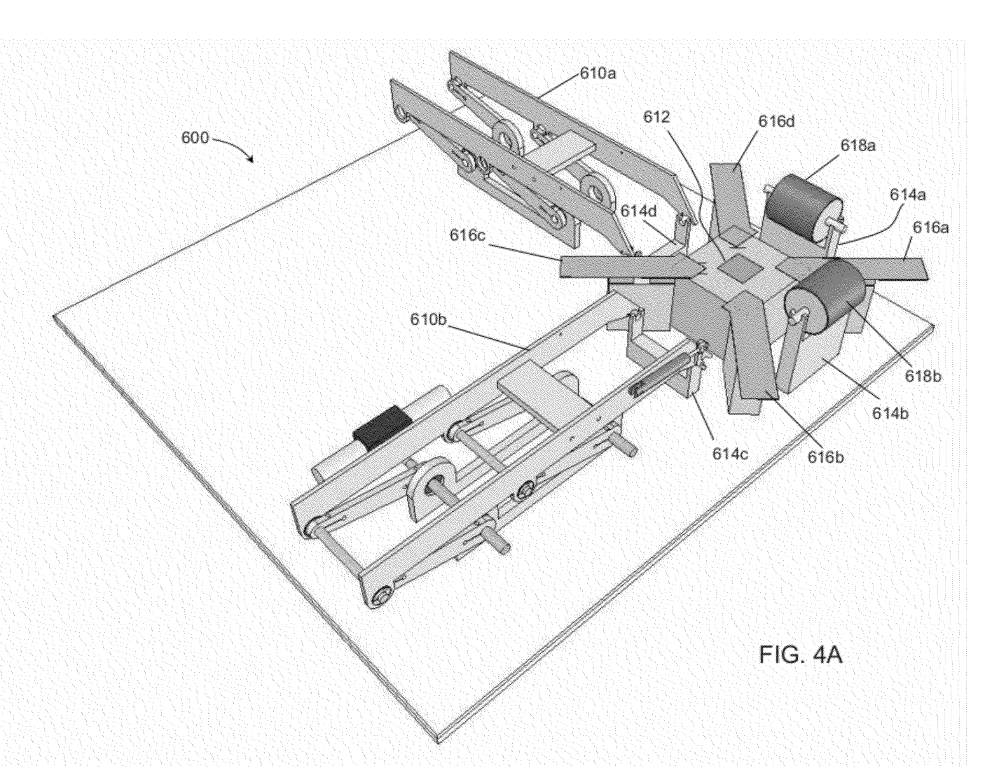

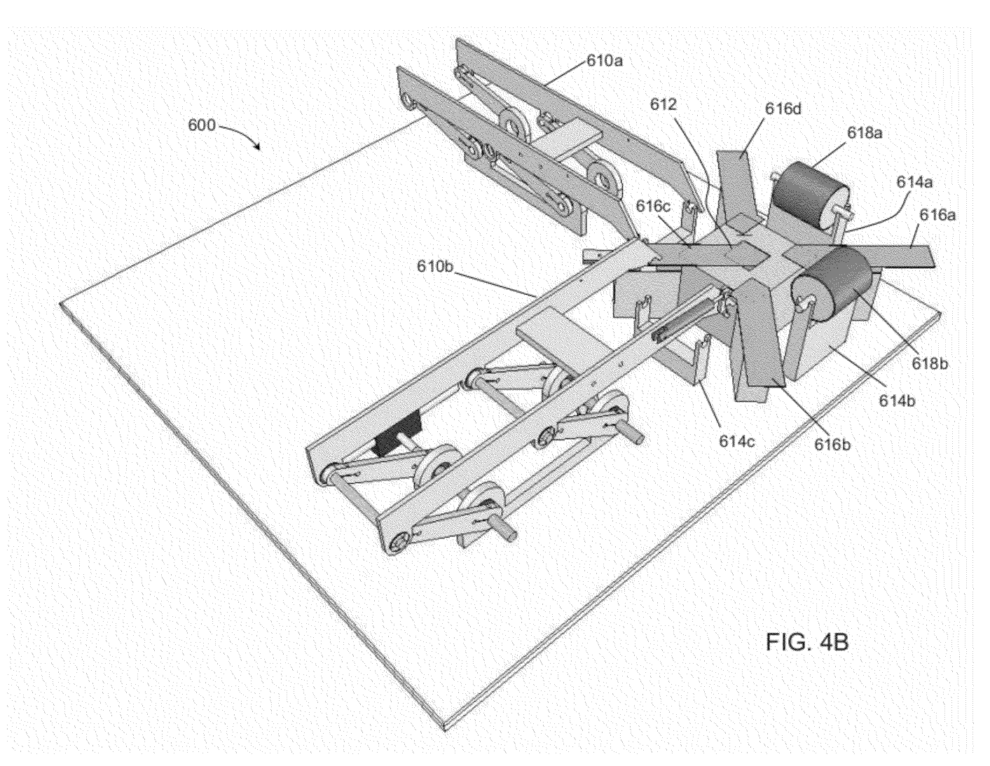

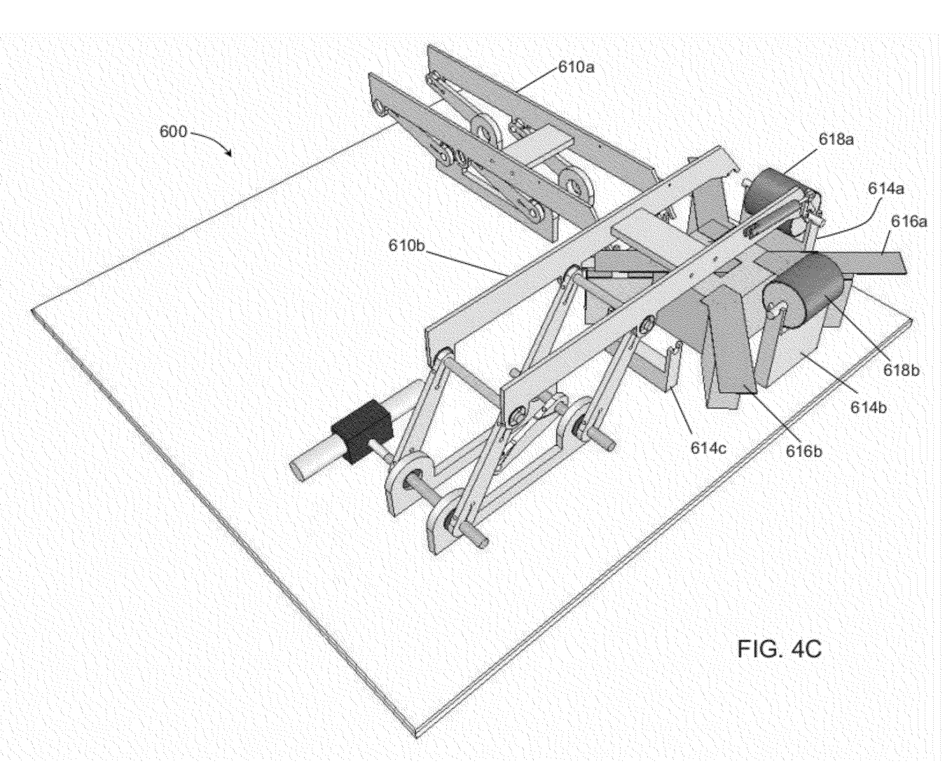

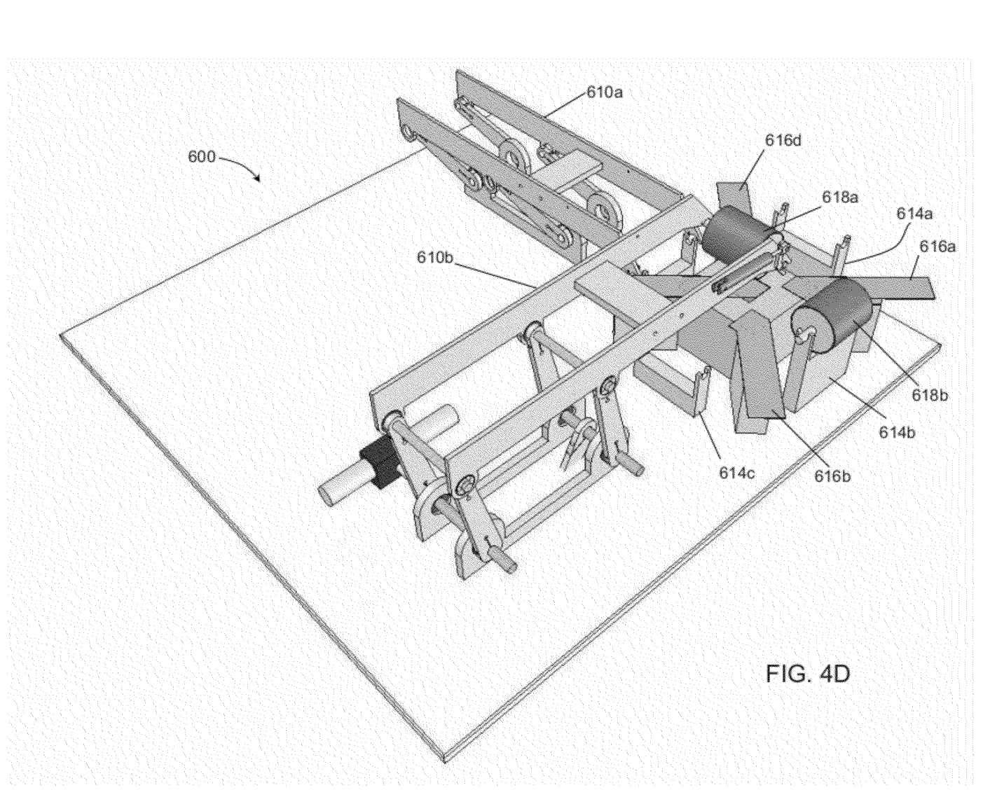

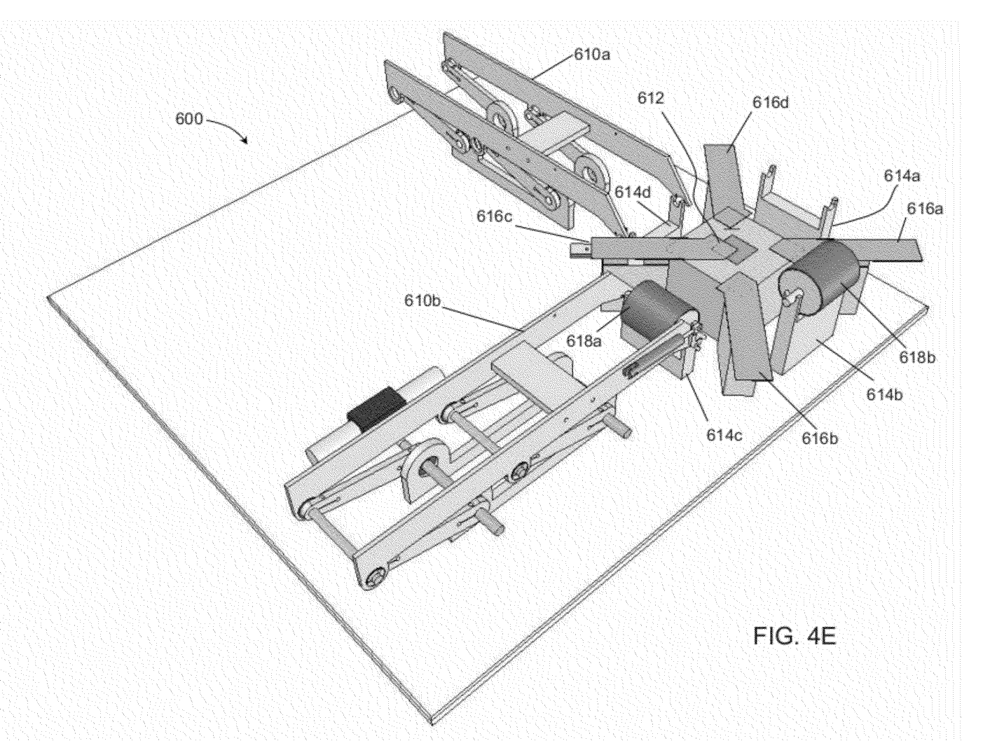

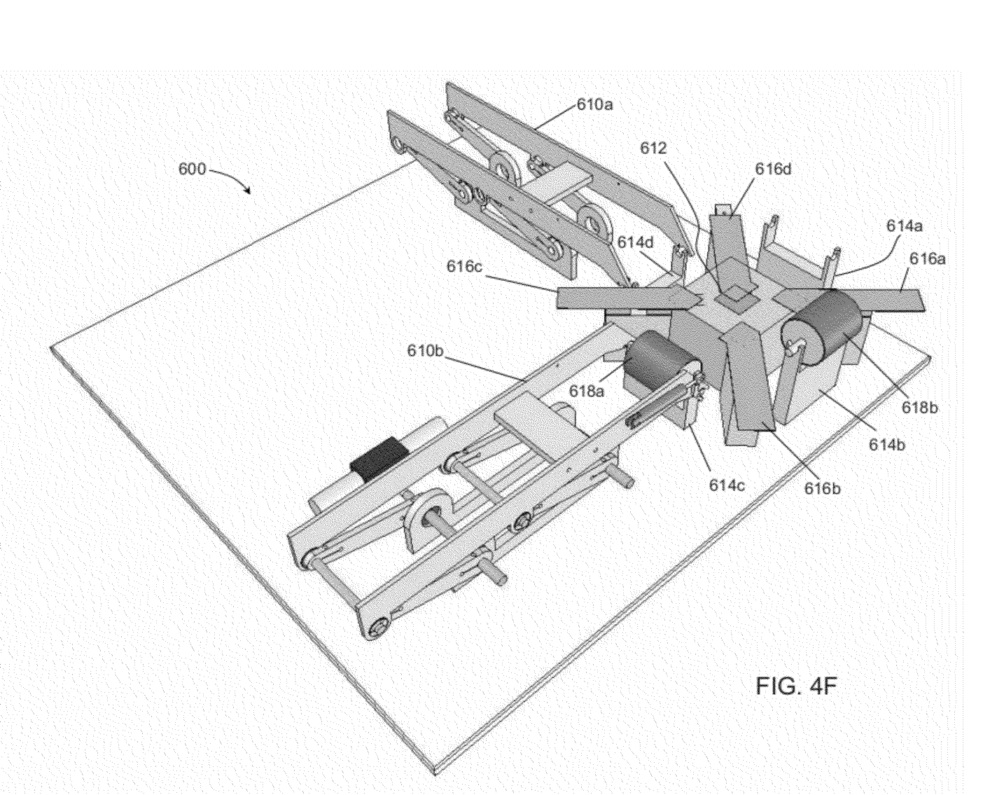

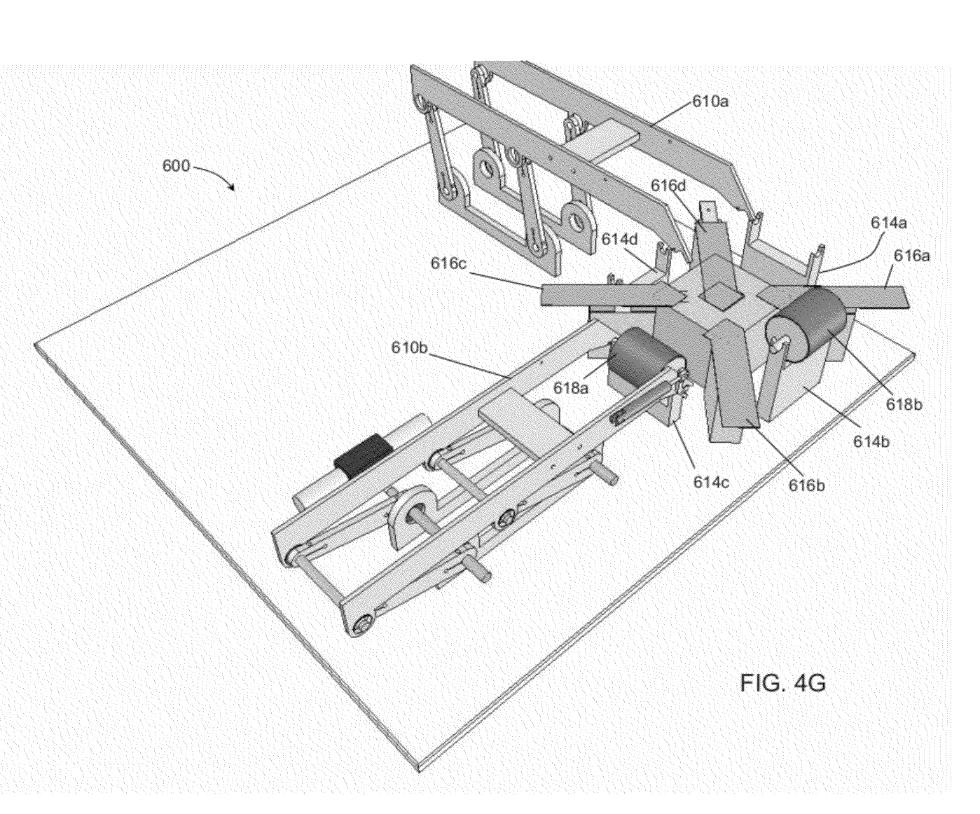

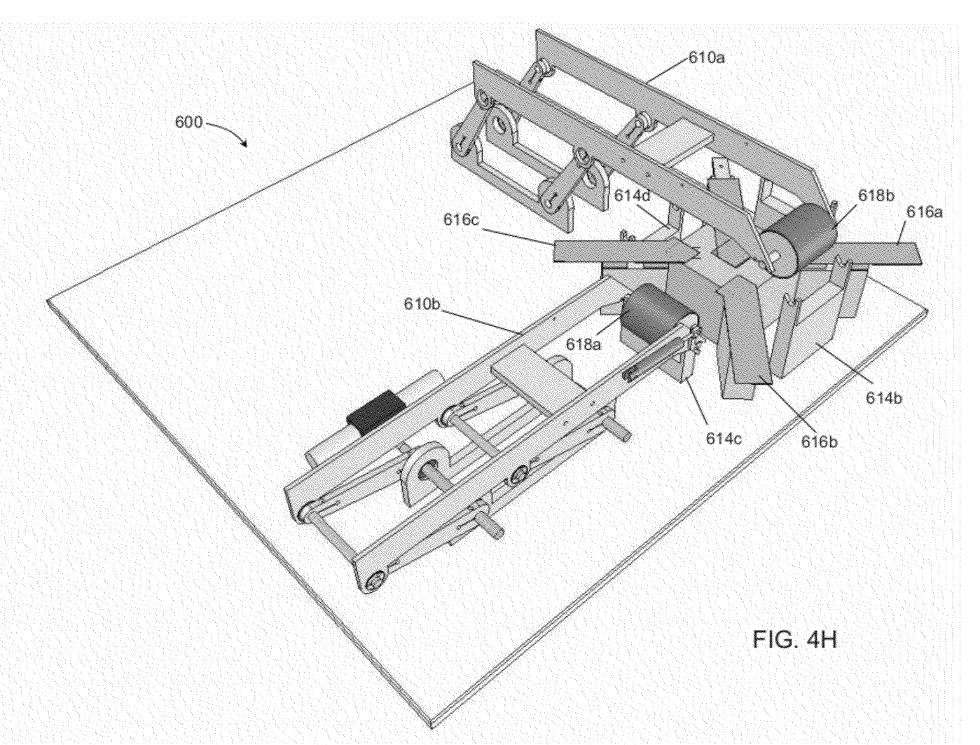

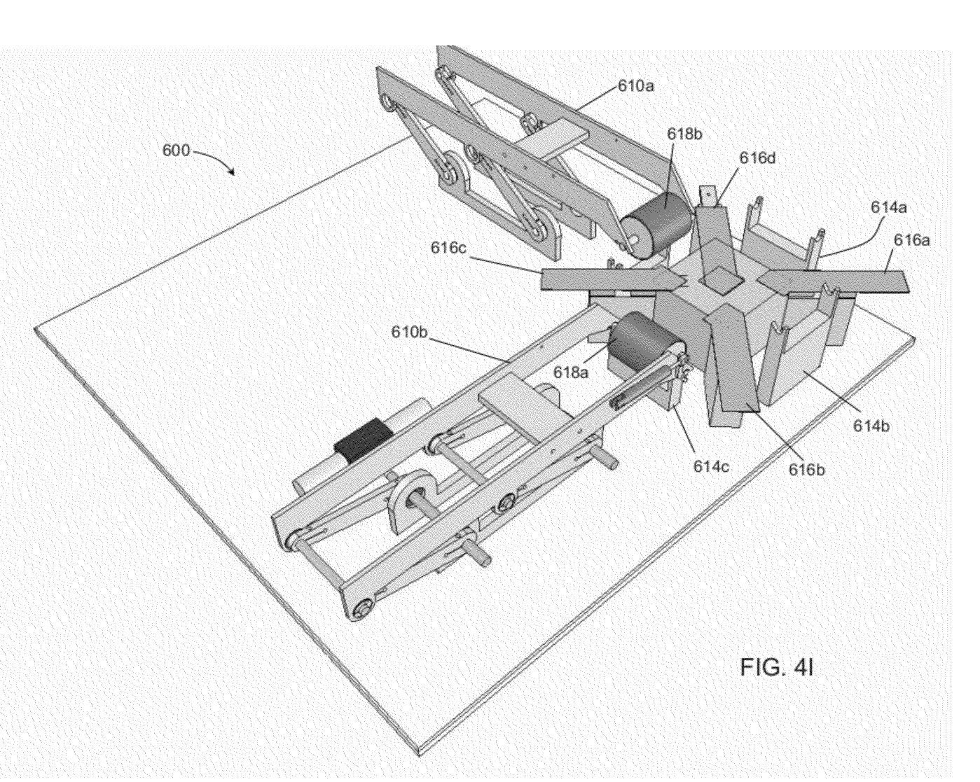

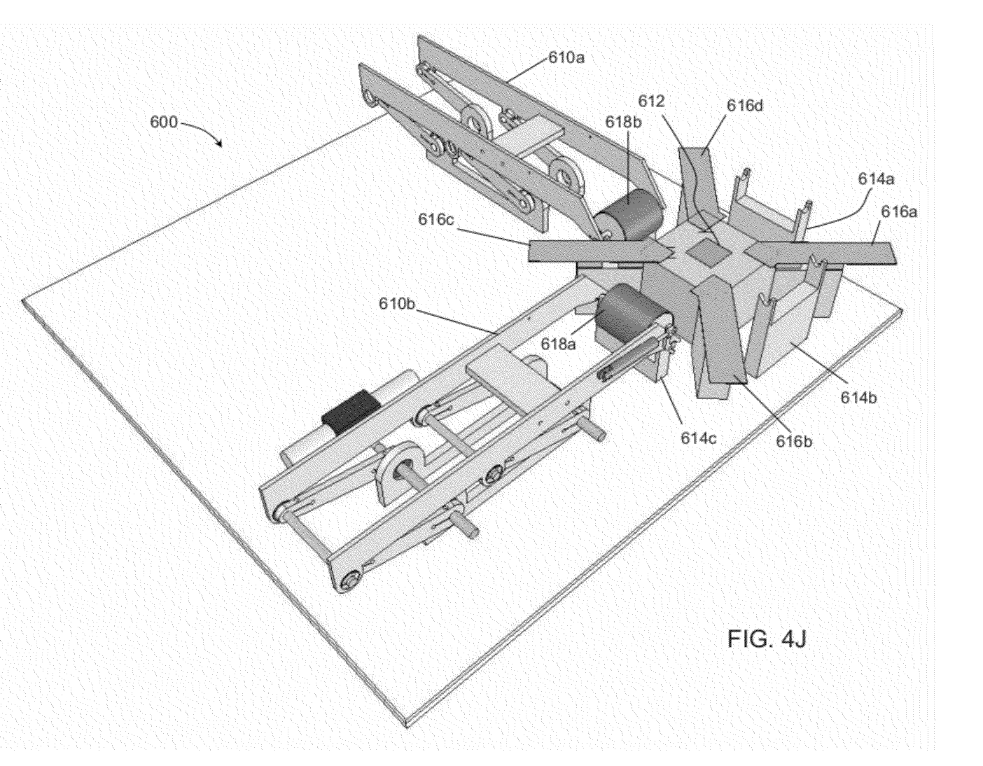

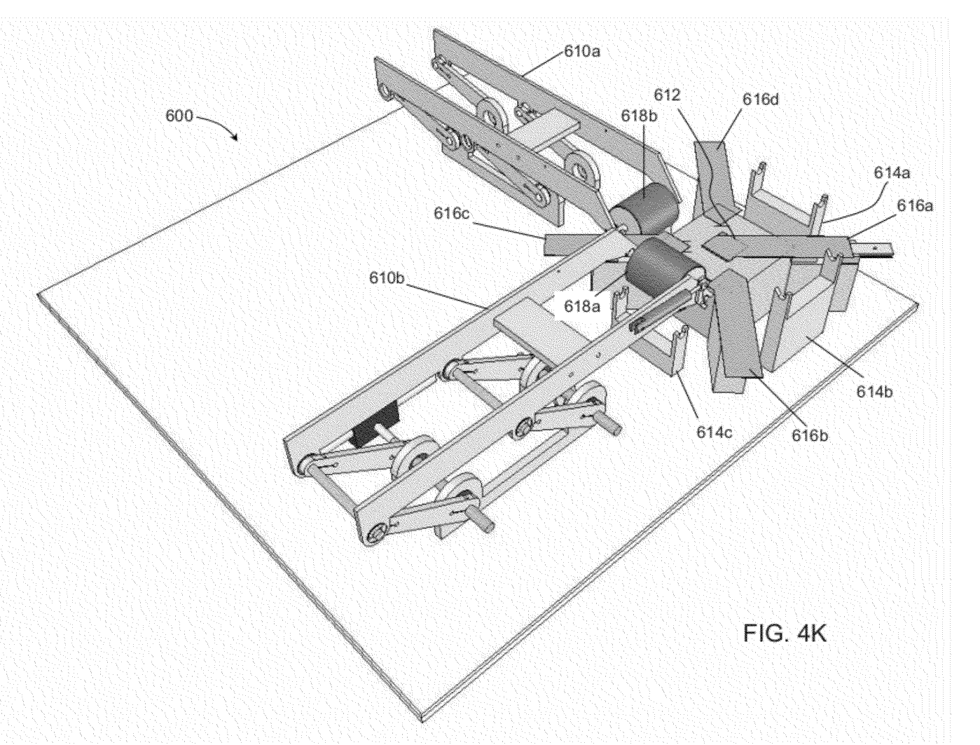

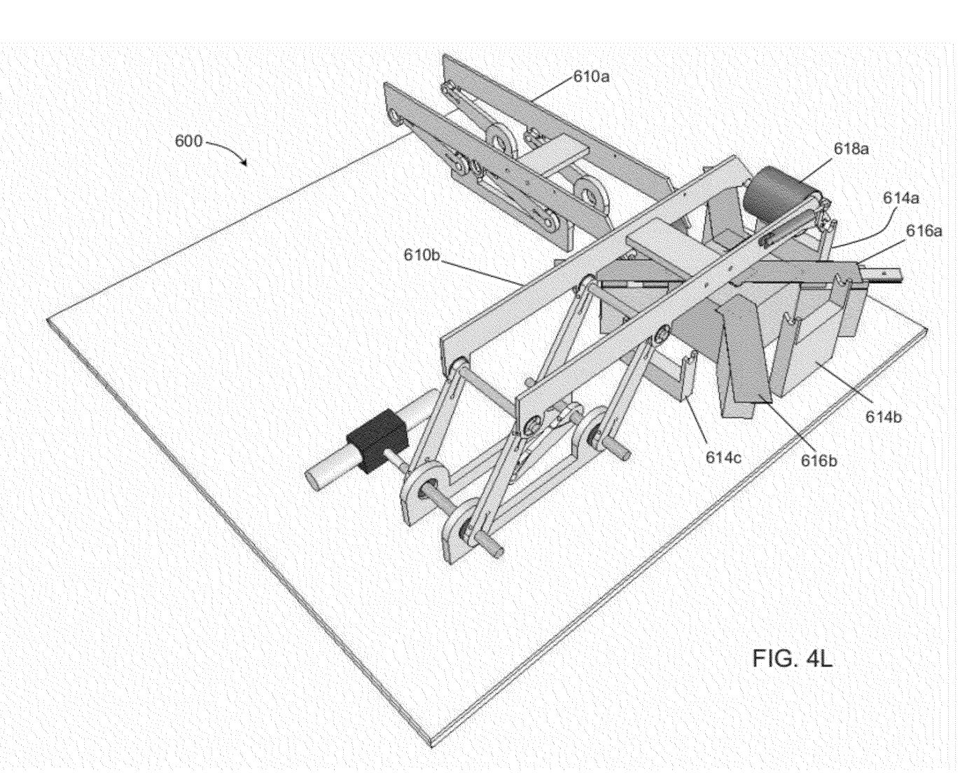

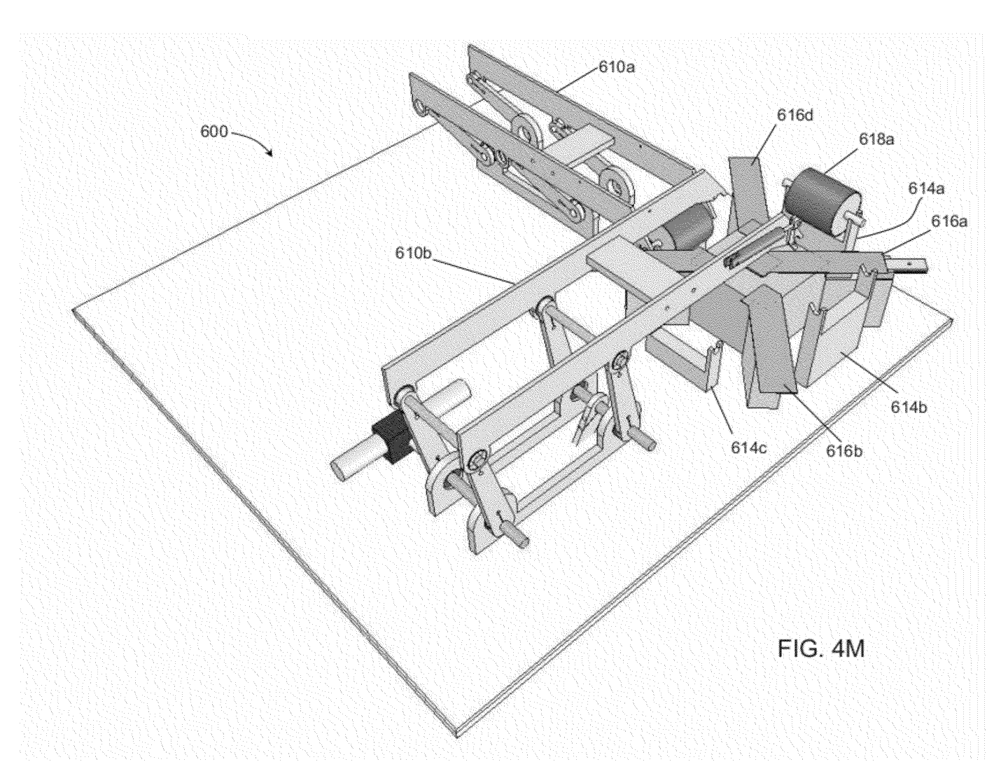

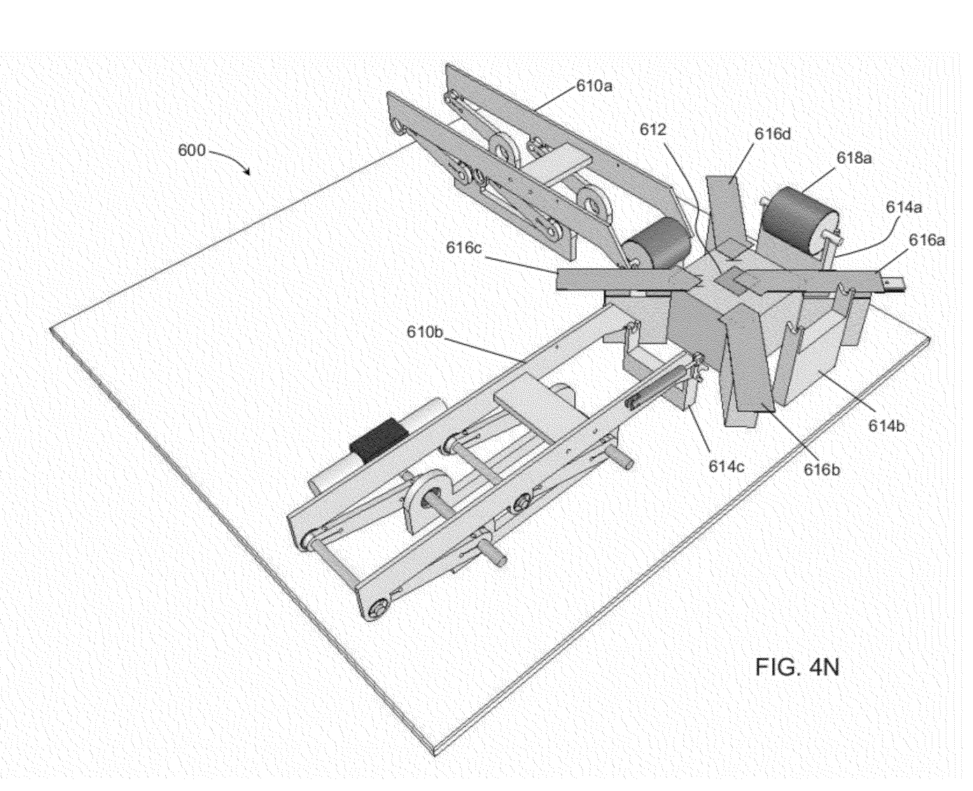

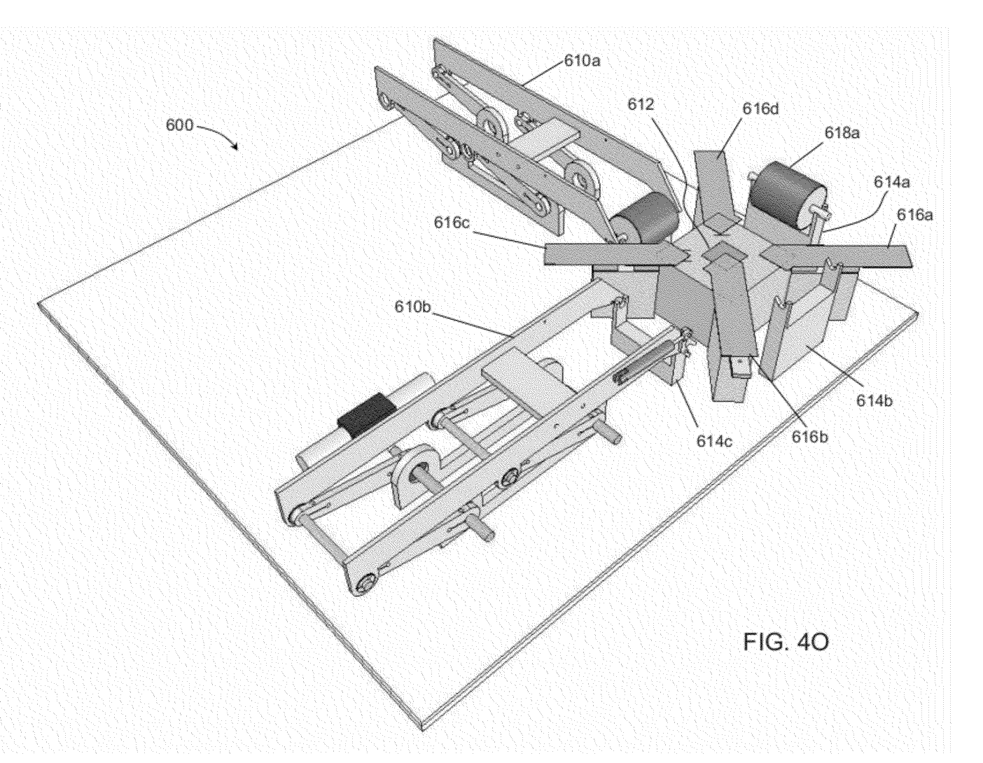

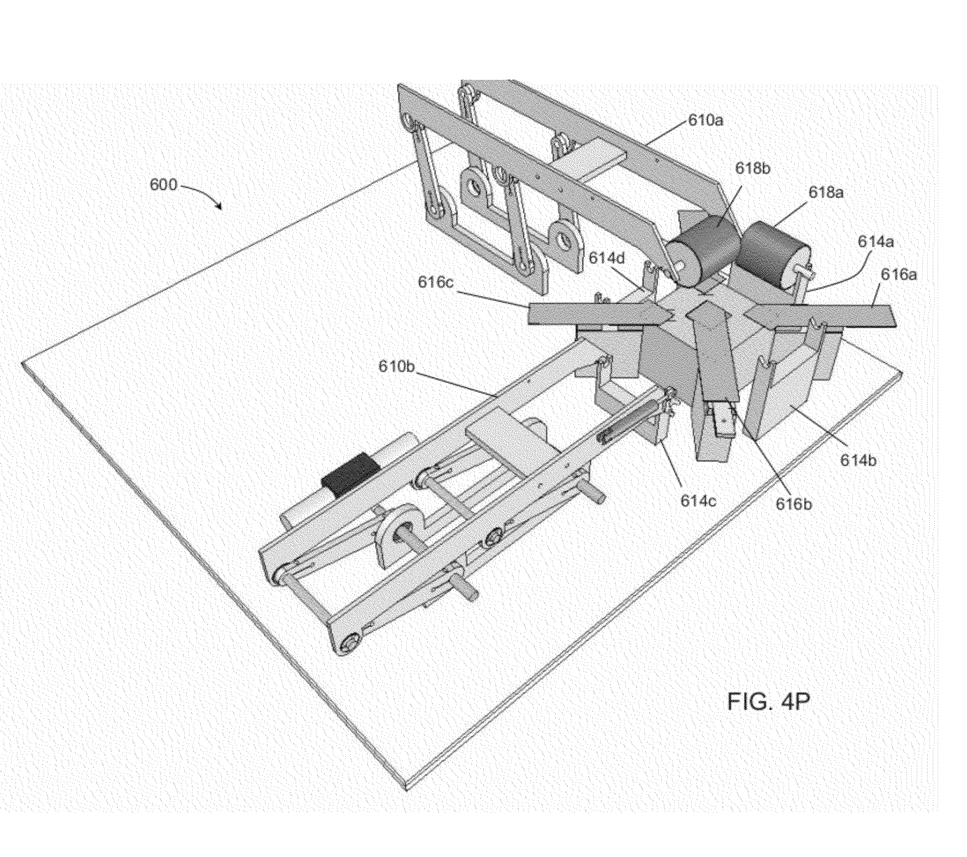

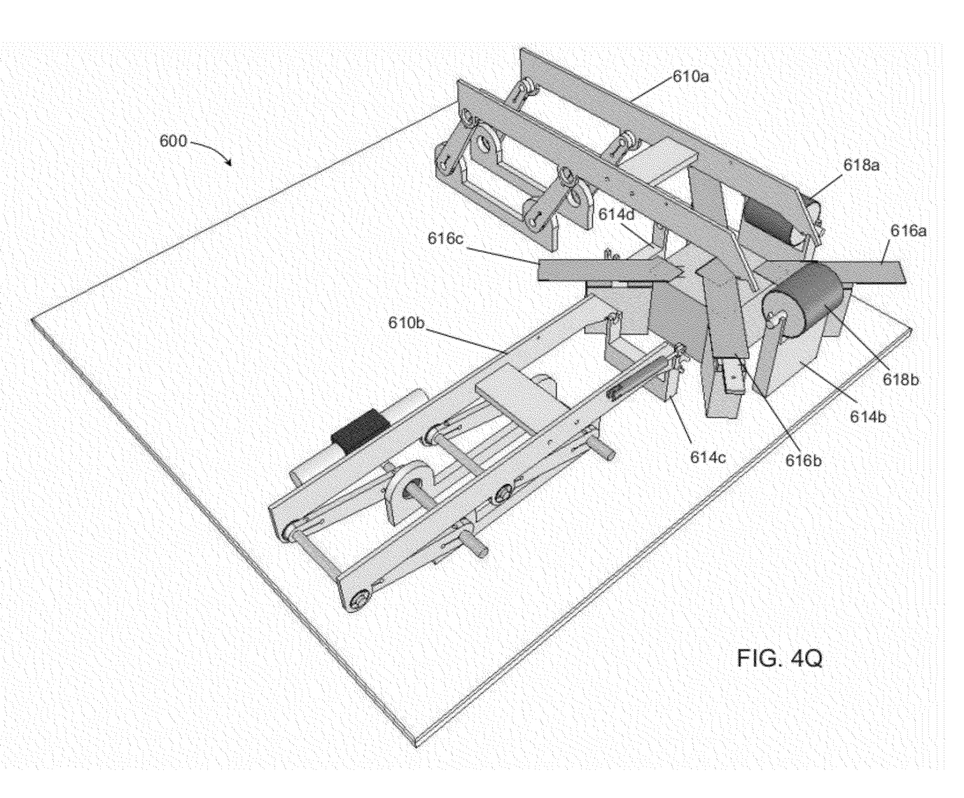

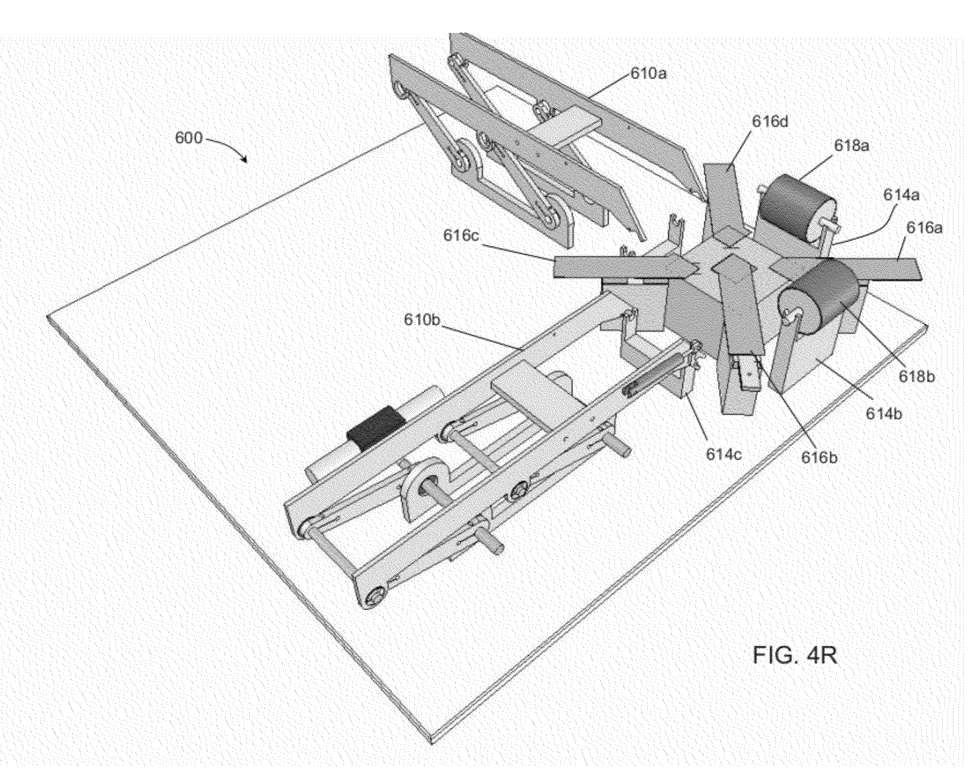

FIGS. 4A-4R are schematic illustrations of a folding stacking machine 600 used to manufacture an electrode stack according to an embodiment. The folding stacking machine 600 has several components including folding arms 610a and 610b (collectively 610), elevator 612 that holds the stack assembly, carriages 614a, 614b, 614c, 614d (collectively 614), an elevator 612, and fingers 616a, 616b, 616c, 616d (collectively 616). Elevator 612 can support the finished electrode stack, and can move up and down to accommodate the change in height of the electrode stack. The carriages 614 hold the electrode material on rolls 618a, 618b (collectively 618). The fingers 616 can be stabilizing members configured to hold electrode strips from the electrode rolls in place while folding arm 610a and folding arm 610b move electrode roll 618a and electrode roll 618b from one carriage to another carriage.

As shown in FIG. 4A, rolls 618a, 618b of electrode material are positioned on carriages 614a, 614b respectively. In FIG. 4B, one finger 616c is deployed covering the elevator 612 and one of the folding arms 610b is moving from a retracted position to a deployed position. FIGS. 4C and 4D show the folding arm 610b retrieving an electrode roll 618a from a carriage 614a and beginning to retract. FIG. 4E shows the folding arm 610b fully retracted such that the electrode roll 618a is now resting on the opposite carriage 614c and the finger 616c has started to retract away from the elevator 612. FIG. 4F shows the finger 616c fully retracted and a different finger 616d is starting to deploy, partially covering the elevator 612. In FIG. 4G, the finger 616d is fully deployed covering the elevator 612 and the other folding arm 610a is moving from a retracted position to a deployed position. FIGS. 4H and 4I show the folding arm 610a retrieving the second electrode roll 618b from the carriage 614b and beginning to retract. FIG. 4J shows the folding arm 610a fully retracted such that the electrode roll 618b is now resting on the opposite carriage 614d and the finger 616d has retracted away from the elevator 612. In FIG. 4K, the finger 616a is deployed covering the elevator 612 and the folding arm 610b is moving from a retracted position to a deployed position. FIGS. 4L-4N show the folding arm 610b moving the electrode roll 618a from one carriage 614c to the opposite carriage 614a and the finger 616a is beginning to retract. FIG. 40 shows the finger 616a fully retracted and the finger 616b is starting to deploy partially covering the elevator 612. FIGS. 4P-4R show the finger 616b fully deployed covering the elevator 612 and the folding arm 610a is moving the electrode roll 618b from one carriage 614d to the opposite carriage 614b. The process is repeated until the desired number of folded layers are produced.

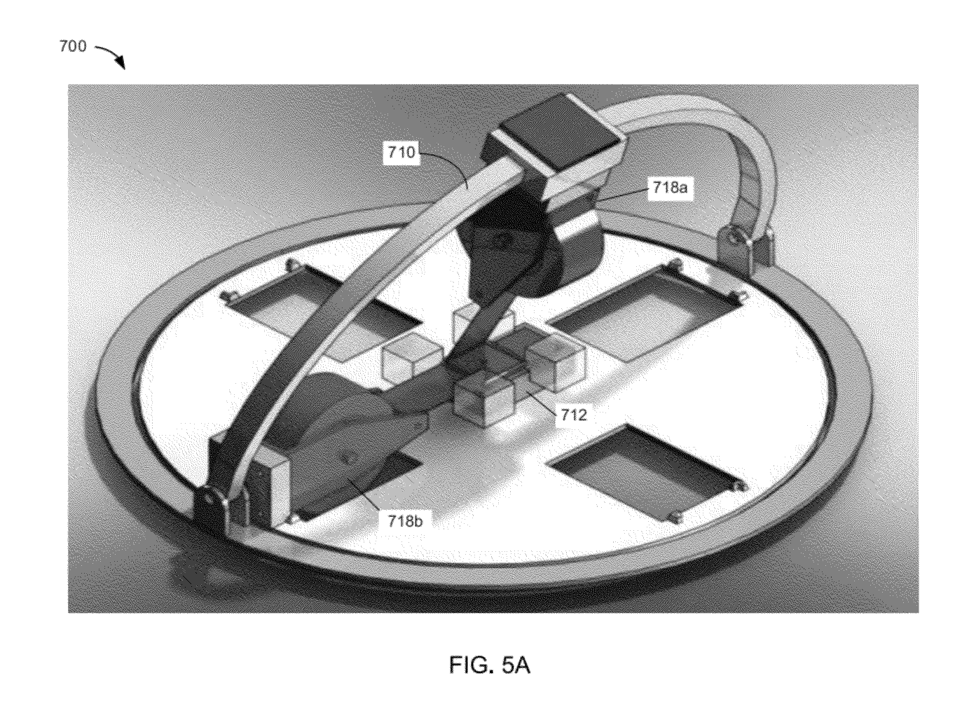

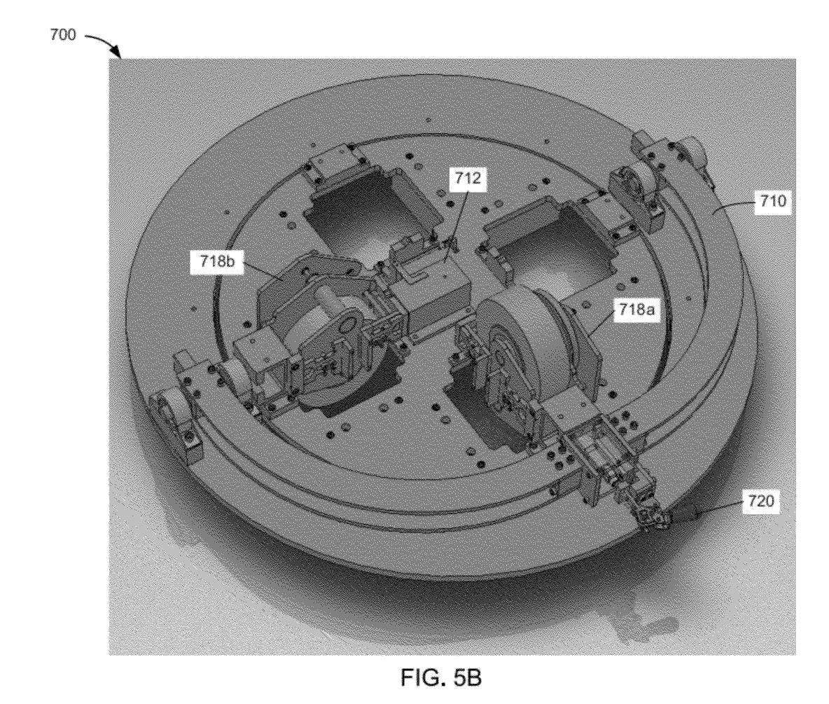

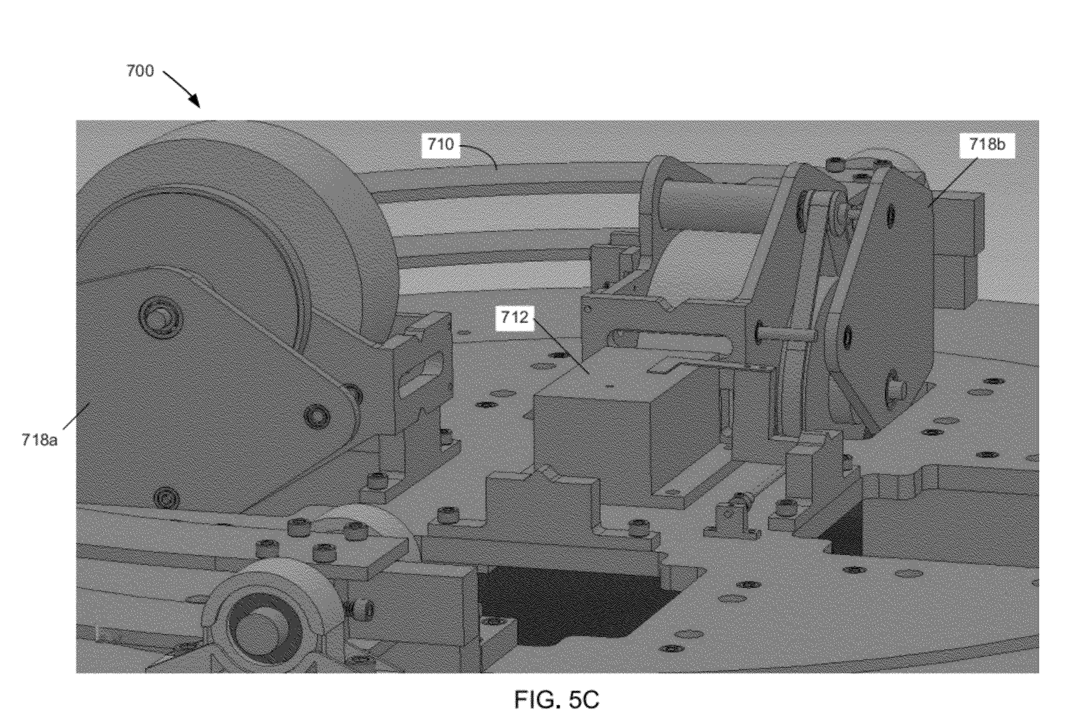

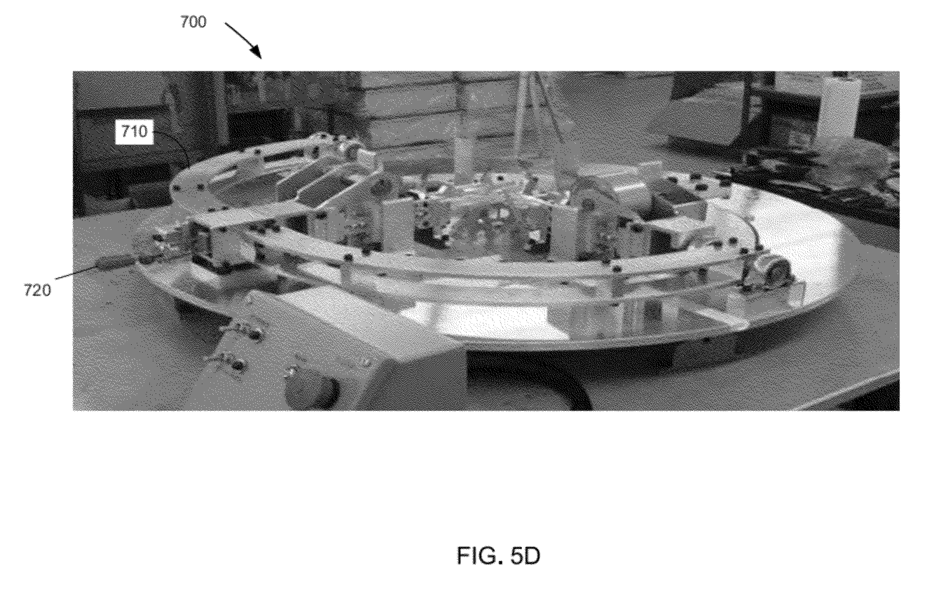

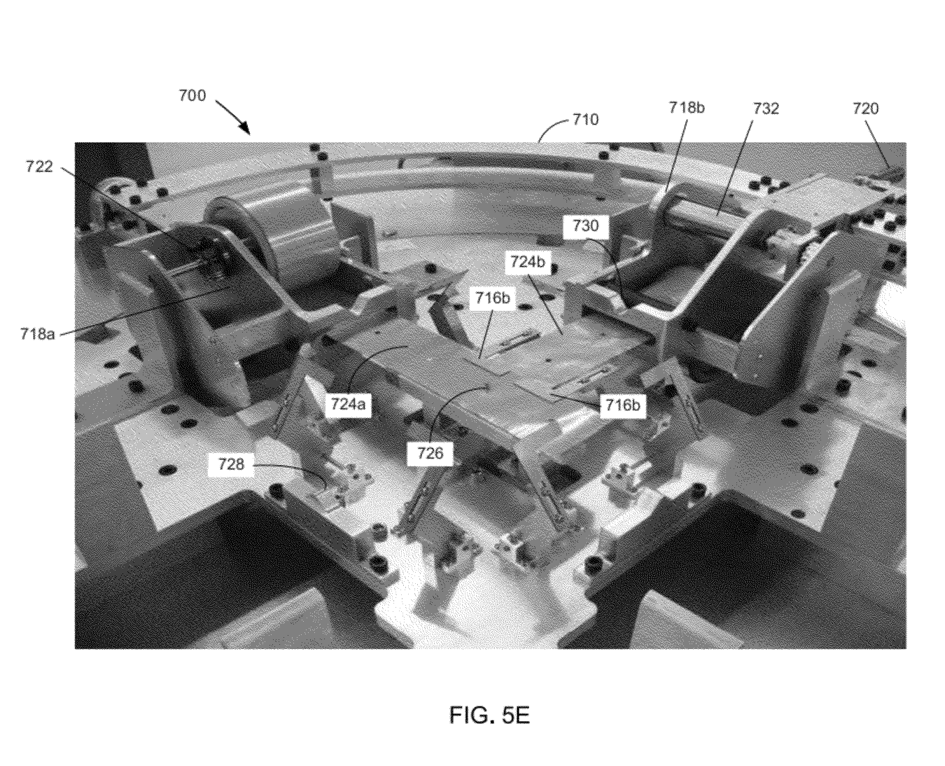

FIGS. 5A-5E are schematic illustrations of a folding stacking machine 700 used to manufacture an electrode stack according to alternative embodiment. The folding stacking machine 700 has several components including the folding bail 710, which is the hinged semi circular portion that executes the folding process, the elevator 712 that holds the finished stack, and the electrode carriages 718a, 718b (collectively 718). The machine can be manual, automatic, semi-automatic, or robotic. The elevator 712 moves up and down to accommodate the stack height. In some embodiments, the elevator 712 has a range of about one inch.

In operation, the folding bail 710 rotates to positions that are ninety degrees from one another and is equipped with a locking pin to ensure that it is in position. The folding bail 710 is shown in FIG. 5A mated to the electrode carriage 718a (the carriage is the device that carries the electrode material on a roll). The carriages 718 float and when the locking mechanism, which is part of the folding bail, is disengaged, the folding bail 710 may be rotated to the other carriage 718. When the locking mechanism is engaged, the carriage 718 is locked in position and becomes rigidly attached to the folding bail 710. The handle 720 (FIG. 5B) is part of the locking mechanism and doubles as a handle 720 that allows an operator to swing the folding bail 710 up and over the elevator 712. The carriage 718 is completely free when disengaged from the folding bail 712 and in order to prevent it from rotating around the axes parallel to the electrode material aluminum angle is used to keep it more or less in an upright position. The carriage rolls 718 are also equipped with tensioning springs 722 (FIG. 5E). The springs are located in the gap between the roll of electrode material and the side of the carriage 718. The springs 722 maintain light tension on the roll so that it does not dispense excess electrode material during the folding operation.

The machine 700, as shown in FIG. 5E, is positioned to fold the electrode material in carriage 718b over the electrode that is in place on the stacking table. Two fingers 716b capture the upper strip 724a (the strip with the pin 726 protruding through it on the stacking table) and the lower strip 724b that has been dispensed from the carriage 718b. The fingers 718b define the crease line. As shown, there are four sets of alignment fingers 716 mounted on rails that allow them to be moved out of position when not in use. When the folding bail 710 is moved through 180 degrees the electrode in quadrant one will be folded over the material that is shown on the stacking table. An alignment anvil 728 mates with an alignment groove 730 on the carriage 718b. This mating of alignment groove 730 and anvil 728 ensures the proper alignment of the mating electrode pieces.

The carriage 718b can then be disengaged from the folding bail 710 and the bail can be rotated clockwise to the carriage 718a. It should be noted that the carriages 718 are fitted with take up reels 732 that are used to store the anti-stick material that will be used with the printed electrode strips. As shown, there is no anti-stick material and thus nothing on the take up reel 732. The fingers 716b are backed out of position and other fingers 716 are engaged and a second fold takes place. The process described is repeated until the stack has accumulated the appropriate number of layers.

A stack can include as many cell components as needed to obtain the desired capacitance. The stack-to-stack interface between stacks can be kept as short as possible. In some embodiments, the stack-to-stack interface between the stacks can be no more than one component in length. There can be as many stack-to-stack interfaces as needed to supply the voltage standoff required for a particular application.

Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

While methods and apparatus are shown and described above as printing and assembling electrodes for EDLCs, in other embodiments, such methods and apparatus can be used to print and/or assemble electrodes for pseudocapacitors, batteries and/or any other device having an electrode. For example, pseudocapacitors have a similar structure and characteristics to EDLCs and can thus, be manufactured using the above described methods. Pseudocapacitors include cells with one electrode having metal oxide as the active material and the other electrode having activated carbon as the active material. The metal oxide can be printed onto a substrate using the methods and apparatus described above. The metal oxide electrode of a pseudocapacitor stores energy using a faradic reaction on the electrode surface (e.g., similar to battery technology) in addition to using surface area storage similar to EDLCs. Accordingly, in some embodiments, a pseudocapacitor can have a higher energy density than a similarly sized EDLC. Moreover, in some embodiments, the load of the metal oxide of a pseudocapacitor is three times the load of an EDLC having similar sized printed electrodes. Accordingly, pseudocapacitor cells can occupy a much smaller volume than an EDLC with the same capacitance.

While various embodiments have been described above, it should be understood that they have been presented by way of example only, and not limitation. Where methods described above indicate certain events occurring in certain order, the ordering of certain events may be modified. Additionally, certain of the events can be performed concurrently in a parallel process when possible, as well as performed sequentially as described above.

Although various embodiments have been described as having particular features and/or combinations of components, other embodiments are possible having a combination of any features and/or components from any of embodiments where appropriate. For example, each stack of electrodes can include any number of cells.

1. An apparatus, including:
a first carriage configured to carry a first current collector, the first current collector including electrode material disposed on a side of the first current collector, and separator material disposed on the electrode material;
a second carriage configured to carry a second current collector, the second current collector including electrode material disposed on a side of the second current collector;
a positioning member configured to be releasably coupled to the first carriage, and configured to move the first carriage from a first position in which the first current collector is not facing the second current collector to a second position in which the electrode material disposed on the second current collector is facing the separator material disposed on the first current collector.

2. The apparatus of claim 1, wherein the electrode material is disposed on the side of the first current collector on a plurality of cell segments, each of the plurality of cell segments physically separated from each other.

3. The apparatus of claim 1, wherein the electrode material is disposed on the side of the second current collector on a plurality of cell segments, each of the plurality of electrode segments physically separated from each other.

4. The apparatus of claim 1, wherein the positioning member is configured to be releasably coupled to the second carriage.

5. The apparatus of claim 1, wherein the positioning member is a first positioning member, and further including a second positioning member configured to be releasably coupled to the second carriage.

6. The apparatus of claim 1, further including a stabilizing member configured to selectively stabilize the second current collector, while the first carriage is moved from the first position to the second position.

7. The apparatus of claim 1, further including a support elevator configured to movably support the first current collector and the second current collector while the first carriage is moved from the first position to the second position.

8. A method, comprising:
moving a first current collector onto a support, the first current collector including electrode material disposed on a side of the first current collector, and separator material disposed on the electrode material;
moving a second current collector onto the first current collector, the second current collector including electrode material disposed on a side of the first current collector;
stabilizing the second current collector; and
folding the first current collector over the second current collector such that the electrode material disposed on the second current collector is facing the separator material disposed on the first current collector.

9. The method of claim 8, wherein the electrode material is disposed on the side of the first current collector on a plurality of cell segments, each of the plurality of electrode segments physically separated from each other.

10. The method of claim 8, wherein the electrode material is disposed on the side of the second current collector on a plurality of cell segments, each of the plurality of electrode segments physically separated from each other.

11. The method of claim 8, wherein folding the first current collector includes folding the current collector over the second current collector such that at least one of a plurality of cell segments of the first current collector is aligned with at least one of a plurality of cell segments of the second current collector.

12. The method of claim 8, further including:
stabilizing the first current collector; and
folding the second current collector over the first current collector such that the electrode material disposed on the second current collector is facing the separator material disposed on the first current collector.

13. The method of claim 8, wherein folding the first current collector includes moving a folding member operatively coupled to a first carriage holding the first current collector from a first position to a second position.

14. The method of claim 8, further comprising lowering the support after folding the first current collector.

15. A method, including:
engaging a first carriage including a first current conductor in a first position, the first current conductor including electrode material disposed on a side of the first current collector on a plurality of cell segments, each of the plurality of cell segments separated from each other by a bare segment;
moving the first carriage from the first position to a second position to dispose the first current collector on a support;
engaging a second carriage including a second current conductor in a third position, the second current conductor including electrode material disposed on a side of the second current collector on a plurality of cell segments, each of the plurality of cell segments separated from each other by a bare segment; and
moving the second carriage from the third position to a fourth position to fold the second current conductor over the first current conductor.

16. The method of claim 15, further including, moving the first carriage from the second position to the first position to fold the first current conductor over the second current conductor.

17. The method of claim 15, further including, moving the second carriage from the fourth position to the third position to fold the second current conductor over the first current conductor.

18. The method of claim 15, wherein engaging the first carriage includes engaging the first carriage with a first folding member and wherein engaging the second carriage includes engaging the second carriage with a second folding member.

19. The method of claim 15, wherein engaging the first carriage includes engaging the first carriage with a folding member and wherein engaging the second carriage includes engaging the second carriage with the folding member.

20. The method of claim 15, further including stabilizing the first current collector prior to moving the second carriage from the third position to the fourth position.
